(19) United States
(12) Patent Application Publication
(10) Pub. No.: US 2023/0308165 A1
(43) Pub. Date: Sep. 28, 2023

(54) ALTERNATE WIRELESS WAN BACKUP ON HOME ROUTERS THROUGH DEDICATED 5GHZ BAND

(71) Applicant: ARRIS Enterprises LLC, Suwanee, GA (US)

(72) Inventors: Sovan ACHARYA, Bangalore (IN); Balaji VINAYAGAM, Chennai (IN); Deepika ARORA, Bangalore (IN); Dileep DEVARAJ, Kollam (IN); Yashaswini AshokKumar, Bengaluru (IN)

(21) Appl. No.: 18/115,907

(22) Filed: Mar. 1, 2023

Related U.S. Application Data
(60) Provisional application No. 63/323,609, filed on Mar. 25, 2022.

(51) Int. Cl. H04B 7/155

(52) U.S. Cl. CPC H04B 7/15507; H04W 88/16

(57) ABSTRACT

A gateway device for use with a wide area network, wireless wide area network, a local area network, a client device and a wireless device, the gateway device being configured to operate in a hotspot mode so as to wirelessly transmit wireless device data and client device data to the wide area network via the wireless wide area network, said gateway device comprising: a memory; a primary communication system; a wireless communication system; and a processor configured to execute instructions stored on said memory to cause said gateway device to: instruct said primary communication system to operate in a primary mode of operation so as to transpond the client device data the wireless device data; detect a loss of connection with the wide area network; and operate in a hotspot mode of operation, wherein said primary communication system and said wireless communication system comprise a radio.

### BACKGROUND

Embodiments of the invention relate to using hot spot device.

### SUMMARY

Aspects of the present invention are drawn to a gateway device for use with a wide area network, wireless wide area network, a local area network, a client device, and a hotspot client device. The client device is configured to transmit client device data to the wide area network via the local area network and the gateway device. The hotspot client device is configured to operate in a first mode so as to wirelessly transmit hotspot client device data to the wide area network via the local area network and the gateway device and is configured to operate in a hotspot mode so as to wirelessly transmit the hotspot client device data and the client device data to the wide area network via the wireless wide area network. The gateway device includes: a memory; a primary communication system configured to transpond the client device data between the client device and the wide area network and to transpond the hotspot client device data between the hotspot client device and the wide area network; a wireless communication system configured to transpond the client device data between the client device and the wide area network via the hotspot client device and the wireless wide area network; and a processor configured to execute instructions stored on the memory to cause the gateway device to: instruct the primary communication system to operate in a primary mode of operation so as to transpond the client device data between the client device and the wide area network and to transpond the hotspot client device data between the hotspot client device and the wide area network; detect a loss of connection with the wide area network; and instruct the primary communication system and the wireless communication system to operate in a hotspot mode of operation so as to transpond the client device data between the client device and the wide area network via the hotspot client device and the wireless wide area network. The primary communication system and the wireless communication system include a radio configured to operate in the primary mode of operation in a band and to simultaneously operate in the hotspot mode of operation in the band.

In some embodiments, the primary communication system includes an Ethernet communication system.

In some further embodiments, the primary communication system additionally includes a wireless communication system.

In some of these embodiments, the primary communication system is configured to transpond the client device data between the client device and the wide area network via a data over a cable service interface specification (DOCSIS) communication channel.

In some of these embodiments, the primary communication system is configured to transpond the client device data between the client device and the wide area network via a data over a passive optical network (PON) communication channel.

In some embodiments, the wireless communication system is configured to operate in the hotspot mode of operation as a client of the hotspot client device so as to transpond the client device data between the client device and the wide area network via the hotspot client device and the wireless wide area network on the band, and to operate in the hotspot mode of operation by providing a fronthaul SSID to the client device on the band.

Other aspects of the present disclosure are drawn to a method of using a gateway device with a wide area network, wireless wide area network, a local area network, a client device and a hotspot client device. The client device is configured to transmit client device data to the wide area network via the local area network and the gateway device. The hotspot client device is configured to operate in a first mode so as to wirelessly transmit hotspot client device data to the wide area network via the local area network and the gateway device and is configured to operate in a hotspot mode so as to wirelessly transmit the hotspot client device data and the client device data to the wide area network via the wireless wide area network. The method includes: instructing, via a processor configured to execute instructions stored on a memory, a primary communication system to operate in a primary mode of operation so as to transpond the client device data between the client device and the wide area network and to transpond the hotspot client device data between the hotspot client device and the wide area network; detecting, via the processor, a loss of connection with the wide area network; and instructing, via the processor, the primary communication system and a wireless communication system to operate in a hotspot mode of operation so as to transpond the client device data between the client device and the wide area network via the hotspot client device and the wireless wide area network. The primary communication system and the wireless communication system include a radio configured to operate in the primary mode of operation in a band and to simultaneously operate in the hotspot mode of operation in the band.

In some embodiments, wherein the instructing, via the processor configured to execute instructions stored on a memory, the primary communication system to transpond the client device data between the client device and the wide area network and to transpond the hotspot client device data between the hotspot client device and the wide area network includes instructing an Ethernet communication system to transpond the client device data between the client device and the wide area network and to transpond the hotspot client device data between the hotspot client device and the wide area network.

In some further embodiments, the instructing, via the processor configured to execute instructions stored on a memory, the primary communication system to transpond the client device data between the client device and the wide area network and to transpond the hotspot client device data between the hotspot client device and the wide area network additionally includes instructing a wireless communication system to transpond a portion of the client device data between the client device and the wide area network and to transpond a portion of the hotspot client device data between the hotspot client device and the wide area network.

In some of these embodiments, the instructing, via the processor configured to execute instructions stored on a memory, the primary communication system to transpond the client device data between the client device and the wide area network and to transpond the hotspot client device data between the hotspot client device and the wide area network includes instructing the primary communication system to transpond the client device data between the client device and the wide area network and to transpond the hotspot client device data between the hotspot client device and the wide area network via a DOCSIS communication channel.

In some of these embodiments, the instructing, via the processor configured to execute instructions stored on a memory, the primary communication system to transpond the client device data between the client device and the wide area network and to transpond the hotspot client device data between the hotspot client device and the wide area network includes instructing the primary communication system to transpond the client device data between the client device and the wide area network and to transpond the hotspot client device data between the hotspot client device and the wide area network via a passive optical network communication channel.

In some embodiments, the instructing the primary communication system and a wireless communication system to operate in a hotspot mode of operation includes instructing the wireless communication system to operate in the hotspot mode of operation as a client of the hotspot client device so as to transpond the client device data between the client device and the wide area network via the hotspot client device and the wireless wide area network on the band, and wherein the instructing the primary communication system and a wireless communication system to operate in a hotspot mode of operation additionally includes instructing the wireless communication system to operate in the hotspot mode of operation by additionally providing a fronthaul SSID to the client device on the band.

Other aspects of the present disclosure are drawn to a non-transitory, computer-readable media having computer-readable instructions stored thereon, wherein the computer-readable instructions are being capable of being read by a gateway device for use with a wide area network, wireless wide area network, a local area network, a client device and a hotspot client device. The client device is configured to transmit client device data to the wide area network via the local area network and the gateway device. The hotspot client device is configured to operate in a first mode so as to wirelessly transmit hotspot client device data to the wide area network via the local area network and the gateway device and is configured to operate in a hotspot mode so as to wirelessly transmit the hotspot client device data and the client device data to the wide area network via the wireless wide area network. The computer-readable instructions are capable of instructing the client device to perform the method including: instructing, via a processor configured to execute instructions stored on a memory, a primary communication system to operate in a primary mode of operation so as to transpond the client device data between the client device and the wide area network and to transpond the hotspot client device data between the hotspot client device and the wide area network; detecting, via the processor, a loss of connection with the wide area network; and instructing, via the processor, the primary communication system and a wireless communication system to operate in a hotspot mode of operation so as to transpond the client device data between the client device and the wide area network via the hotspot client device and the wireless wide area network, wherein the primary communication system and the wireless communication system comprise a radio configured to operate in the primary mode of operation in a band and to simultaneously operate in the hotspot mode of operation in the band.

In some embodiments, the computer-readable instructions are capable of instructing the client device to perform the method wherein the instructing, via the processor configured to execute instructions stored on a memory, the primary communication system to transpond the client device data between the client device and the wide area network and to transpond the hotspot client device data between the hotspot client device and the wide area network includes instructing an Ethernet communication system to transpond the client device data between the client device and the wide area network and to transpond the hotspot client device data between the hotspot client device and the wide area network.

In some further embodiments, the computer-readable instructions are capable of instructing the client device to perform the method wherein the instructing, via the processor configured to execute instructions stored on a memory, the primary communication system to transpond the client device data between the client device and the wide area network and to transpond the hotspot client device data between the hotspot client device and the wide area network additionally includes instructing a wireless communication system to transpond a portion of the client device data between the client device and the wide area network and to transpond a portion of the hotspot client device data between the hotspot client device and the wide area network.

In some of these embodiments, the computer-readable instructions are capable of instructing the client device to perform the method wherein the instructing, via the processor configured to execute instructions stored on a memory, the primary communication system to transpond the client device data between the client device and the wide area network and to transpond the hotspot client device data between the hotspot client device and the wide area network includes instructing the primary communication system to transpond the client device data between the client device and the wide area network and to transpond the hotspot client device data between the hotspot client device and the wide area network via a DOCSIS communication channel.

In some embodiments, the computer-readable instructions are capable of instructing the client device to perform the method wherein the instructing, via the processor configured to execute instructions stored on a memory, the primary communication system to transpond the client device data between the client device and the wide area network and to transpond the hotspot client device data between the hotspot client device and the wide area network includes instructing the primary communication system to transpond the client device data between the client device and the wide area network and to transpond the hotspot client device data between the hotspot client device and the wide area network via a passive optical network communication channel.

In some embodiments, the computer-readable instructions are capable of instructing the client device to perform the method wherein the instructing the primary communication system and a wireless communication system to operate in a hotspot mode of operation includes instructing the wireless communication system to operate in the hotspot mode of operation as a client of the hotspot client device so as to transpond the client device data between the client device and the wide area network via the hotspot client device and the wireless wide area network on the band, and wherein the instructing the primary communication system and a wireless communication system to operate in a hotspot mode of operation additionally includes instructing the wireless communication system to operate in the hotspot mode of operation by additionally providing a fronthaul SSID to the client device on the band.

### BRIEF SUMMARY OF THE DRAWINGS

The accompanying drawings, which are incorporated in and form a part of the specification, illustrate example embodiments and, together with the description, serve to explain the principles of the invention. In the drawings:

FIG. 1A illustrates a communication system at a time t₀;

FIG. 1B illustrates a communication system at a time t₁;

FIG. 2 illustrates a method for using a hotspot to alternatively connect a gateway device to the Internet in accordance with aspects of the present disclosure;

FIG. 3A illustrates a communication system at a time t₀ in accordance with aspects of the present disclosure;

FIG. 3B illustrates a communication system at a time t₁ in accordance with aspects of the present disclosure;

FIG. 3C illustrates a communication system at a time t₂ in accordance with aspects of the present disclosure; and

FIG. 4 illustrates an exploded view of a hotspot client device, a client device, and a gateway device in accordance with aspects of the present disclosure.

### DETAILED DESCRIPTION

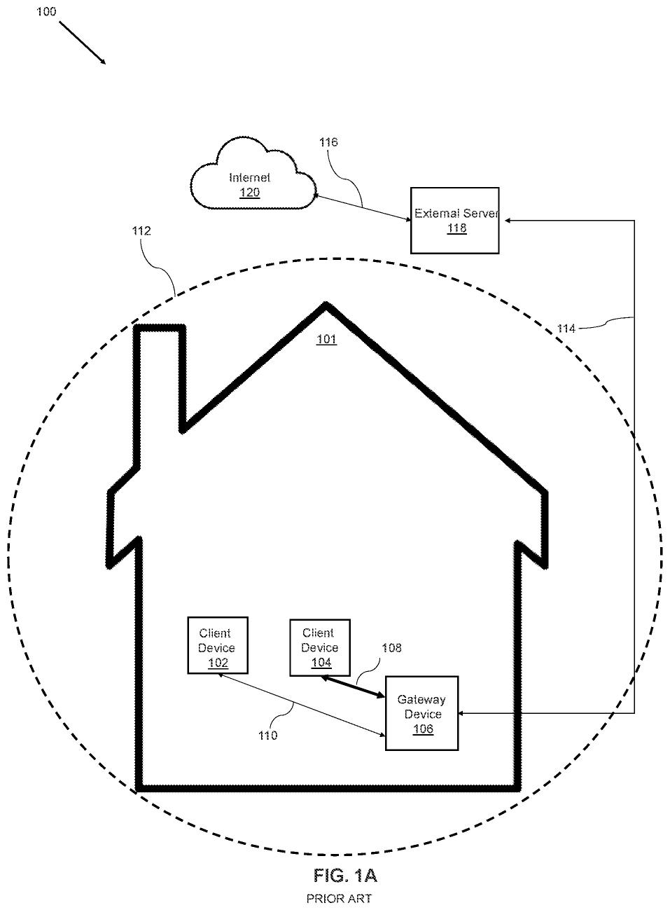

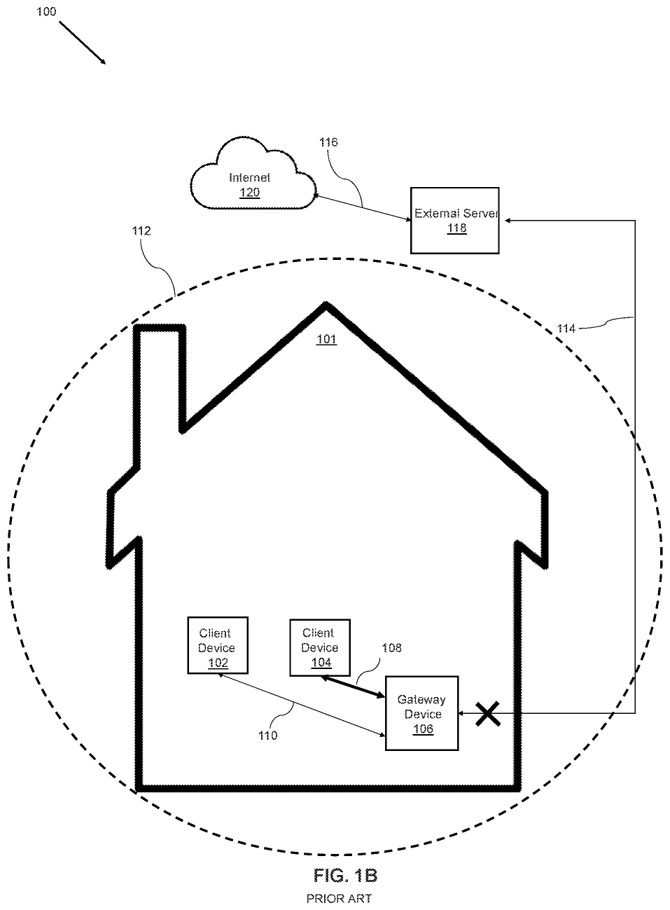

FIG. 1A illustrates a communication system 100 at a time t₀.

As shown in FIG. 1A, communication system 100 includes: client devices 102 and 104; a gateway device 106; a wired communication channel 108; wireless communication channel 110; communication channels 114, and 116; a local area network (LAN) 112; an external server 118; and Internet 120.

Client devices 102 and 104 may be any devices or systems that present content to, accept inputs from, or directly or indirectly interact with a user. In this non-limiting example, client devices 102 and 104 may be smart phones, tablets, personal computers, TV set-top boxes, videogame consoles, smart media devices, home security devices, or Internet-of-Things (IoT) devices.

Gateway device 106 is a device that combines the functions of a modem and a router. A modem is a device that connects to cable or phone lines and translates the data or information from the Internet to a computer or connected device. A router is a device that works with the modem to create and manage a wireless network so as to wirelessly take the data coming through the modem and sends it wirelessly to multiple devices like smart phones, tablets, gaming consoles, and computers. The consumer premises can include a residential dwelling, an office, or any other business space of a user, such as residence 101. The terms home, office, and premises may be used synonymously herein.

Gateway device 106 may perform such functions as Web acceleration and HTTP compression, flow control, encryption, redundancy switchovers, traffic restriction policy enforcement, data compression, TCP performance enhancements (e.g., TCP performance enhancing proxies, such as TCP spoofing), quality of service functions (e.g., classification, prioritization, differentiation, random early detection (RED), TCP/UDP flow control), bandwidth usage policing, dynamic load balancing, and routing.

Further, it should be noted that gateway device 106 is able to communicate with external server 118 via communication channel 114, which may optionally be a wireless communication system, such as 4G, or 5G, or may optionally be any known type of wired communication channels, non-limiting examples of which include Ethernet, DSL, and Fiber. Gateway device 106 is further is able to connect to Internet 120 via communication channel 116, which may optionally be a wireless communication system, such as 4G, or 5G, or may optionally be any known type of wired communication channels, non-limiting examples of which include Ethernet, DSL, and fiber.

Gateway device 106 serves as a gateway or access point to Internet 120 for one or more electronic devices.

A wireless access point (WAP), or more generally known as an access point (AP), is a networking hardware device that allows other Wi-Fi devices to connect to a Wi-Fi network. A service set ID (SSID) is an identification (in IEEE 802.11) that is broadcast by access points in beacon packets to announce the presence of a network access point for the SSID. SSIDs are customizable IDs that can be zero to 32 bytes, and can be in a natural language, such as English. In residence 101, gateway device 106 is an access point.

Client device 102 is wirelessly connected to gateway device 106. Client device 104 is physically connected to gateway device 106, e.g., through an Ethernet interface.

LAN 112 is created and managed through gateway device 106. LAN 112 is illustrated as a single network, merely for purposes of discussion. It should be noted that LAN 112 may represent a plurality of local area networks created and managed through gateway device 106. LAN 112 is a communication network where client device 102 can wirelessly communicate with gateway device 106 in order to access Internet 120 through communication channel 114, external server 118, and communication channel 116. Client device 104 is connected to LAN 112 through wired communication channel 108. As such, for purposes of this discussion, LAN 112 includes a wireless network for client device 102 to wireless communicate with gateway device 106 and a wired network, e.g., an Ethernet network, for client device 104 to communicate with gateway device 106.

FIG. 1B illustrates communication system 100 at a time t₁.

As shown in FIG. 1B, communication channel 114 has been disconnected. Gateway device 106 no longer has access to Internet 120. Non-limiting examples of reasons for gateway device 106 being disconnected from Internet 120 include: inclement weather; a cable line being cut; or connectivity issues with the wired or wireless communication functions of gateway device 106.

In instances where the gateway device is disconnected from the WAN, it can be inconvenient to users operating network devices. In particular, client device 104 may still communicate with gateway device 106 via wired communication channel 108 and client device 102 may communicate with gateway device 106 via wireless communication channel 110. However, if either of client device 104 or client device 102 are attempting to access Internet 120 via gateway device 106, in instances where the communication between gateway device 106 and Internet 120 is down, client device 104 and client device 102 will also be unable to access Internet 120. While these instances may be few and far between, some will be more inconvenient than others due to the length of time that the gateway device is disconnected from the Internet. There needs to be a way for users to minimize time without Internet access while the gateway device attempts to reconnect to the network.

What is needed is a system and method for alternatively connecting to a WAN in instance where the communication between a gateway device and an external WAN are down.

A system and method in accordance with the present disclosure alternatively connects to a WAN in instance where the communication between a gateway device and an external WAN are down.

In accordance with the present disclosure, a gateway device is used with a hotspot client device. The hotspot client device will connect to the network associated with the gateway device. The gateway device and hotspot client device will communicate with one another during a primary mode of operation, where all connected devices communicate with a WAN through the gateway device. In the case of the gateway device is disconnected from the WAN, the gateway device will operate in a secondary mode of operation. The gateway device will instruct the hotspot client device to begin operating as a hotspot. The gateway device, including a 2.4 GHz radio and a 5 GHz radio, will continue acting as an access point and provide a fronthaul connection for all connected devices through both radios. The 5 GHz radio will simultaneously communicate with the hotspot client device and act as a client. For purposes of discussion only, let the WAN be the Internet in example embodiments disclosed herein. As such, it should be noted that in a broader sense, a gateway device in accordance with aspects of the present disclosure may additionally be used with any WAN.

The hotspot client device may then connect to the Internet by an alternate method, e.g., via a cellular network through the use of a cellular radio. The gateway device will connect to the hotspot client device on the 5 GHz radio, and thereby be connected to the Internet through the hotspot client device. The hotspot client device will temporarily provide Internet access to all devices connected to the gateway device. Once the gateway device is again able to connect to the Internet, the gateway device will instruct the hotspot client device to stop operating as a hotspot. In this way, all the client devices will still have access to the Internet when the direct communication between the gateway device and the Internet is disrupted.

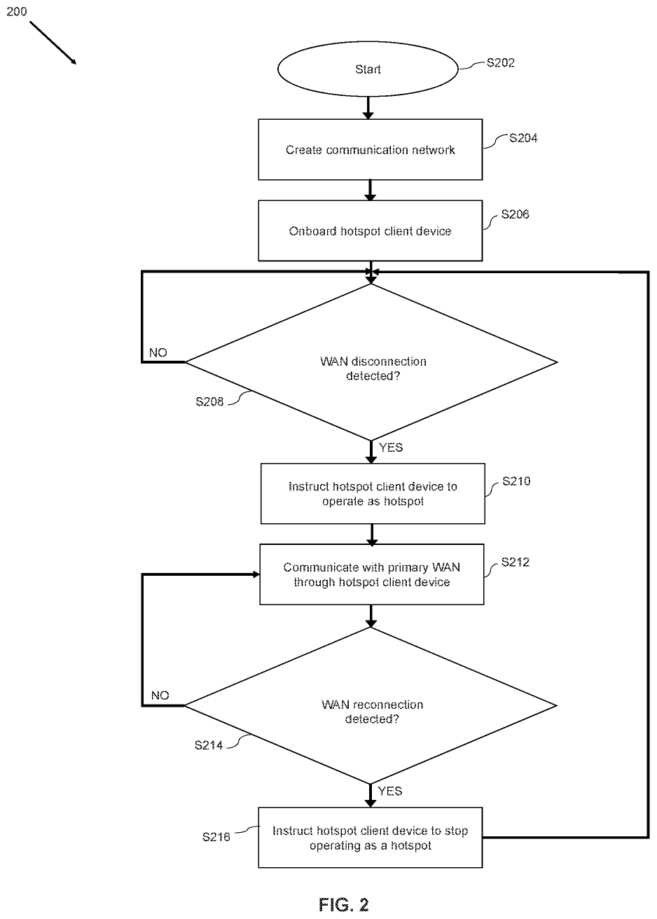

An example system and method for alternatively connecting to a WAN in instance where the communication between a gateway device and an external WAN are down in accordance with aspects of the present disclosure will now be described in greater detail with reference to FIGS. 2-4.

FIG. 2 illustrates an algorithm 200 to be executed by a processor for using a hotspot to alternatively connect a gateway device to the Internet in accordance with aspects of the present disclosure.

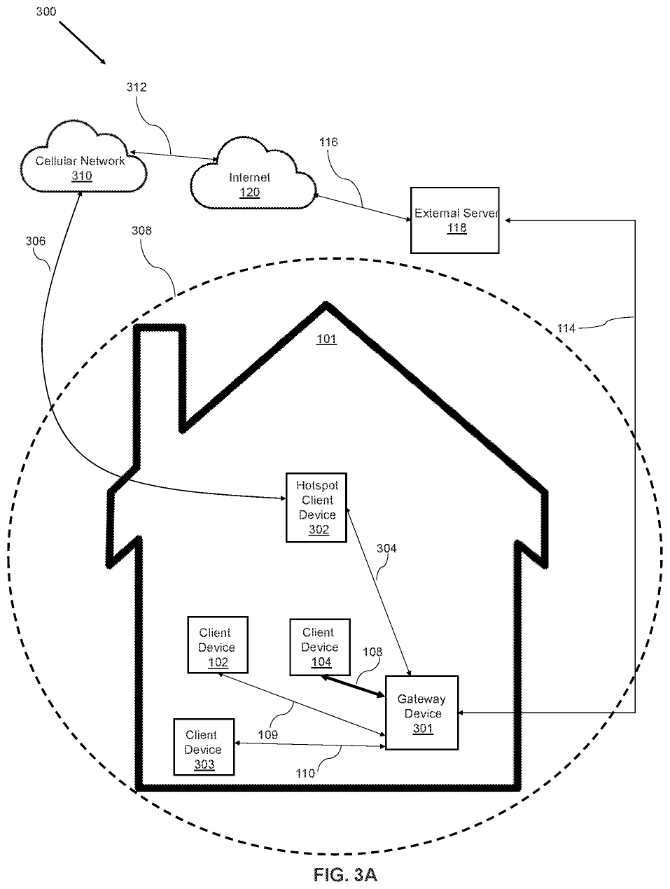

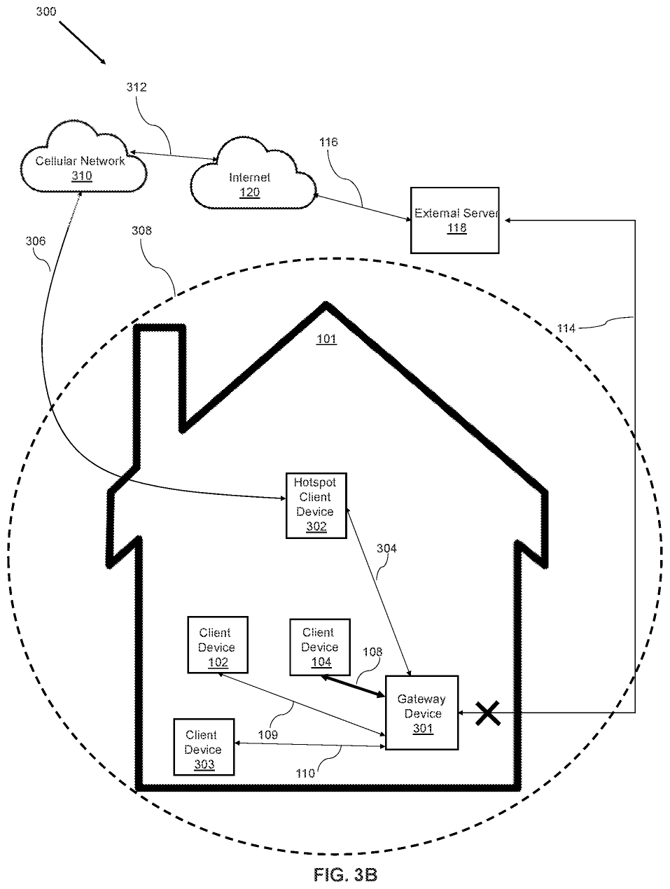

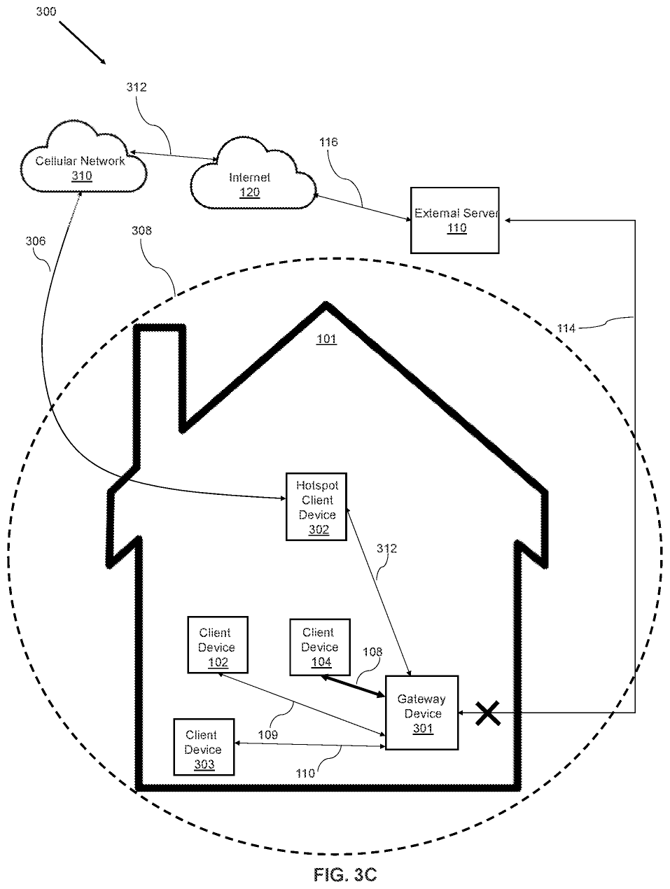

As shown in FIG. 2, algorithm 200 starts (S202) and a communication network is created (S204). This will be described in greater detail with reference to FIG. 3A.

FIG. 3A illustrates a communication system 300 at a time t₀ in accordance with aspects of the present disclosure.

As shown in FIG. 3A, communication system 300 includes: client devices 102, 104, and 303; a hotspot client device 302; a gateway device 301; wired communication channel 108; wireless communication channels 109, 110, 114, 116, and 304; a local area network (LAN) 308; a cellular communication channel 306; external server 118; Internet 120; and a cellular network 310.

Gateway device 301 is a device that combines the functions of a modem and a router. A modem is a device that connects to cable or phone lines and translates the data or information from the Internet to a computer or connected device. A router is a device that works with the modem to create and manage a wireless network so as to wirelessly take the data coming through the modem and sends it wirelessly to multiple devices like smart phones, tablets, gaming consoles, and computers. The consumer premises can include a residential dwelling, an office, or any other business space of a user, such as residence 101. The terms home, office, and premises may be used synonymously herein.

Gateway device 301 may perform such functions as Web acceleration and HTTP compression, flow control, encryption, redundancy switchovers, traffic restriction policy enforcement, data compression, TCP performance enhancements (e.g., TCP performance enhancing proxies, such as TCP spoofing), quality of service functions (e.g., classification, prioritization, differentiation, random early detection (RED), TCP/UDP flow control), bandwidth usage policing, dynamic load balancing, and routing.

Further, it should be noted that gateway device 301, in a primary mode of operation, is able to communicate with external server 118 via communication channel 114, which may optionally be a wireless communication system, such as 4G, or 5G, and further is able to connect to Internet 120 via communication channel 116. Further, as will be described in greater detail below, gateway device 301, in a hotspot mode of operation, is additionally able to communicate with external server 118, when communication channel 114 is down, alternatively via hotspot client device 302, communication channel 306, cellular network 310 communication channel 312, internet 120 and communication channel 116 in accordance with aspects of the present disclosure.

Gateway device 301 serves as a gateway or access point to Internet 120 for one or more electronic devices.

Hotspot client device 302 is connected to gateway device 301 wirelessly. Further, hotspot client device 302 is able to connect to internet 120 through cellular communication channel 306, cellular network 310, and wireless communication channel 312.

Further, it should be noted that hotspot client device 302, in a primary mode of operation, is able to communicate with gateway device 301, and is further able to connect to Internet 120 through gateway device 301. Further, as will be described in greater detail below, hotspot client device 302, in a hotspot mode of operation, is additionally able to communicate with cellular network 310 via communication channel 306 and further is able to connect to Internet 120 via communication channel 312.

LAN 308 is created and managed through gateway device 301. LAN 308 is illustrated as a single network, merely for purposes of discussion. It should be noted that LAN 308 may represent a plurality of local area networks created and managed through gateway device 301. LAN 308 is a communication network where client device 102 can wirelessly communicate with gateway device 301 in order to access Internet 120 through communication channel 114, external server 118, and communication channel 116. Client device 104 is connected to LAN 308 through wired communication channel 108. As such, for purposes of this discussion, LAN 308 includes a wireless network for client device 102 to wireless communicate with gateway device 301 and a wired network, e.g., an Ethernet network, for client device 104 to communicate with gateway device 301.

It should be noted that LAN 308 is illustrated and discussed to include a single wireless network and a single wired network. However, in accordance with aspects of the present disclosure, gateway device 301 may create and manage a plurality of distinct local area networks. As such, LAN 308 is representative of a summation of local area networks created and managed by gateway device 301. Further, gateway device 301 is configured to act as a bridge for communications from the summation of local area networks to the Internet.

In operation, client devices 102 and 303 may onboard onto LAN 308 through known wireless protocols, a non-limiting example of which includes Wi-Fi network protocols. Similarly, client device 104 may connect to LAN 308 by known protocols, a non-limiting example of which includes Ethernet protocol. Therefore, in this example, LAN 308 includes client devices 102, 104, and 303 and gateway device 301.

After a communication network is created (S204), the hotspot client device is onboarded (S206). For example, hotspot client device 302 may onboard to LAN 308 through known wireless protocols, a non-limiting example of which includes Wi-Fi protocols. Once onboarded, hotspot client device 302 is connected to the same wireless network as client device 102 and is able to wirelessly communicate with gateway device 301.

Hotspot client device 302 is similar to client devices 102 and 303, in that hotspot client device 302 may communicate with gateway device 301 over the local wireless network created and managed by gateway device 301. However, hotspot client device 302 differs from client device 102, in that hotspot client device is additionally capable of connecting to Internet 120 through cellular communication channel 306 and becoming a Wi-Fi hotspot for gateway device 301.

In some embodiments, at least one of client device 102, client device 104, and client device 303 may be configured to become a Wi-Fi hotspot for gateway device 301 in instances where wireless communication channel 114 is inactive. For purposes of the discussion only, in this example, hotspot client device 302 will be configured to act as a hotspot for gateway device 301.

At this point, primary communication system 430 is operating

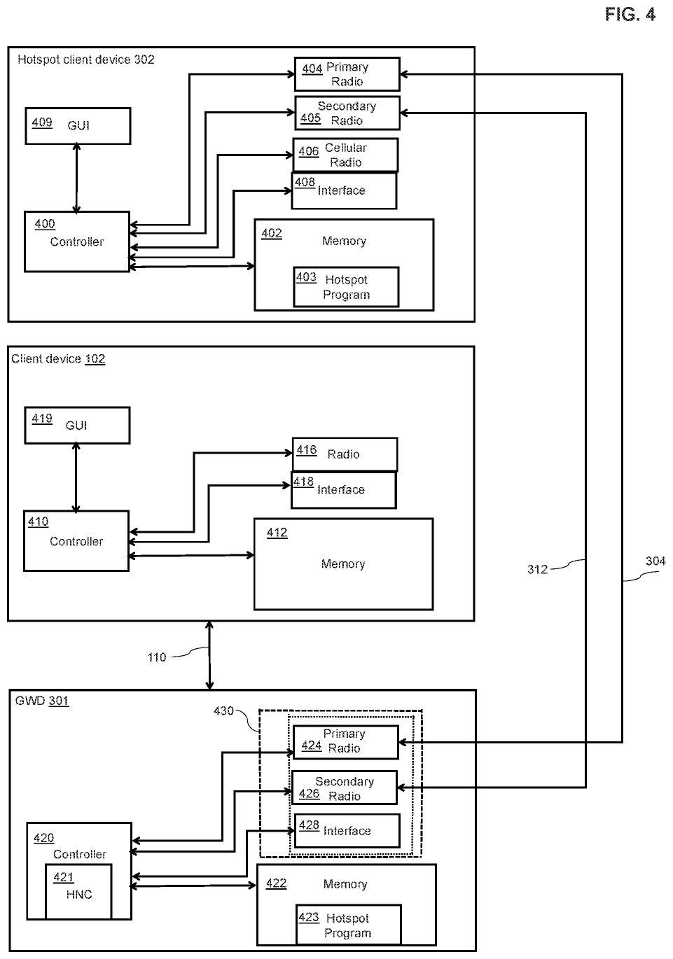

After the hotspot client device is onboarded (S206), it is determined if the Internet has disconnected (S208). This will be described in greater detail with reference to FIG. 4.

FIG. 4 illustrates an exploded view of hotspot client device 302, client device 102, and gateway device 301.

As shown in FIG. 4, hotspot client device 302 includes a controller 400; a memory 402, which has stored therein a hotspot program 403; at least one radio, a sample of which is illustrated as a primary radio 404, a secondary radio 405 and a cellular radio 406; an interface 408; and a graphic user interface (GUI) 409.

In this example, controller 400, memory 402, primary radio 404, secondary radio 405, cellular radio 406, and interface 408 are illustrated as individual devices. However, in some embodiments, at least two of controller 400, memory 402, primary radio 404, secondary radio 405, and cellular radio 406, and interface 408 may be combined as a unitary device. Further, in some embodiments, at least one of controller 400 and memory 402 may be implemented as a computer having tangible computer-readable media for carrying or having computer-executable instructions or data structures stored thereon. Such non-transitory computer-readable recording medium refers to any computer program product, apparatus or device, such as a magnetic disk, optical disk, solid-state storage device, memory, programmable logic devices (PLDs), DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, includes compact disc (CD), laser disc, optical disc, digital versatile disc (DVD), floppy disk and Blu-ray disc. Combinations of the above are also included within the scope of computer-readable media. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of computer-readable media.

Example tangible computer-readable media may be coupled to a processor such that the processor may read information from and write information to the tangible computer-readable media. In the alternative, the tangible computer-readable media may be integral to the processor. The processor and the tangible computer-readable media may reside in an integrated circuit (IC), an application specific integrated circuit (ASIC), or large scale integrated circuit (LSI), system LSI, super LSI, or ultra LSI components that perform a part or all of the functions described herein. In the alternative, the processor and the tangible computer-readable media may reside as discrete components.

Example tangible computer-readable media may also be coupled to systems, non-limiting examples of which include a computer system/server, which is operational with numerous other general purpose or special purpose computing system environments or configurations. Examples of well-known computing systems, environments, and/or configurations that may be suitable for use with computer system/server include, but are not limited to, personal computer systems, server computer systems, thin clients, thick clients, handheld or laptop devices, multiprocessor systems, microprocessor-based systems, set-top boxes, programmable consumer electronics, network PCs, minicomputer systems, mainframe computer systems, and distributed cloud computing environments that include any of the above systems or devices, and the like.

Such a computer system/server may be described in the general context of computer system-executable instructions, such as program modules, being executed by a computer system. Generally, program modules may include routines, programs, objects, components, logic, data structures, and so on that perform particular tasks or implement particular abstract data types. Further, such a computer system/server may be practiced in distributed cloud computing environments where tasks are performed by remote processing devices that are linked through a communications network. In a distributed cloud computing environment, program modules may be located in both local and remote computer system storage media including memory storage devices.

Components of an example computer system/server may include, but are not limited to, one or more processors or processing units, a system memory, and a bus that couples various system components including the system memory to the processor.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

A program/utility, having a set (at least one) of program modules, may be stored in the memory by way of example, and not limitation, as well as an operating system, one or more application programs, other program modules, and program data. Each of the operating system, one or more application programs, other program modules, and program data or some combination thereof, may include an implementation of a networking environment. The program modules generally carry out the functions and/or methodologies of various embodiments of the application as described herein.

Controller 400 may be implemented as a hardware processor such as a microprocessor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software for controlling the operation and functions of hotspot client device 302 in accordance with the embodiments described in the present disclosure.

Memory 402, as will be described in greater detail below, has instructions, including hotspot program 403, stored therein to be executed by controller 400 to allow hotspot client device 302 to: receive instructions from gateway device 301 to operate as a hotspot; operate as a hotspot for LAN 308; and receive instructions from gateway device 301 to stop operating as a hotspot.

Primary radio 404 and secondary radio 405 may include a Wi-Fi WLAN interface radio transceiver that is operable to communicate with gateway device 301, as shown in FIG. 3A, and also may include a cellular transceiver operable to communicate with a cellular network. Primary radio 404, secondary radio 405, and cellular radio 406 include one or more antennas and communicates wirelessly via one or more of the 2.4 GHz band, the 5 GHz band, the 6 GHz band, and the 60 GHz band, or at the appropriate band and bandwidth to implement any IEEE 802.11 Wi-Fi protocols, such as the Wi-Fi 4, 5, 6, or 6E protocols. Hotspot client device 302 can also be equipped with a radio transceiver/wireless communication circuit to implement a wireless connection in accordance with any Bluetooth protocols, Bluetooth Low Energy (BLE), or other short range protocols that operate in accordance with a wireless technology standard for exchanging data over short distances using any licensed or unlicensed band such as the CBRS band, 2.4 GHz bands, 5 GHz bands, 6 GHz bands or 6E GHz bands, RF4CE protocol, ZigBee protocol, Z-Wave protocol, or IEEE 802.15.4 protocol.

Primary radio 404 is configured to allow hotspot client device 302 to communicate with gateway device 301, when operating in a primary mode of operation. Secondary radio 405 is configured to communicate with gateway device 301, in a hotspot mode of operation, wherein wireless communication channel 114 has been disconnected from gateway device 301. In other words, in a primary mode of operation, primary radio 404 is active and secondary radio 405 is inactive. However, in a hotspot mode of operation, primary radio 404 is inactive and secondary radio 405 is active.

Cellular radio 406 is configured to communicate with cellular network 310 when gateway device 301 no longer has connection to Internet 120, due to the disconnection of wireless communication channel 114.

As shown in FIG. 3A, cellular radio 406 is configured to enable hotspot client device 302 to wirelessly communicate with cellular network 310 over communication channel 306, by known cellular protocols.

Returning to FIG. 4, interface 408 can include one or more connectors, such as RF connectors, or Ethernet connectors, and/or wireless communication circuitry, such as 5G circuitry and one or more antennas.

GUI 409 may be any known device or system to display an interactive image to enable a user to interact with hotspot client device 302.

Client device 102 includes a controller 410; a memory 412; a radio 416; an interface 418; and a GUI 419.

In this example, controller 410, memory 412, radio 416, and interface 418 are illustrated as individual devices. However, in some embodiments, at least two of controller 410, memory 412, primary radio 414, secondary radio 416, and interface 418 may be combined as a unitary device. Further, in some embodiments, at least one of controller 410 and memory 412 may be implemented as a computer having tangible computer-readable media for carrying or having computer-executable instructions or data structures stored thereon.

Controller 410 may be implemented as a hardware processor such as a microprocessor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software for controlling the operation and functions of client device 102 in accordance with the embodiments described in the present disclosure.

Memory 412 can store various programming, user content, and data.

Radio 416 may include a Wi-Fi WLAN interface radio transceiver that is operable to communicate with gateway device 301. Radio 416 includes one or more antennas and communicate wirelessly via one or more of the 2.4 GHz band, the 5 GHz band, the 6 GHz band, and the 6E GHz band, or at the appropriate band and bandwidth to implement any IEEE 802.11 Wi-Fi protocols, such as the Wi-Fi 4, 5, 6, or 6E protocols. Radio 416 can also be equipped with a radio transceiver/wireless communication circuit to implement a wireless connection in accordance with any Bluetooth protocols, Bluetooth Low Energy (BLE), or other short range protocols that operate in accordance with a wireless technology standard for exchanging data over short distances using any licensed or unlicensed band such as the CBRS band, 2.4 GHz bands, 5 GHz bands, 6 GHz bands or 6E GHz bands, RF4CE protocol, ZigBee protocol, Z-Wave protocol, or IEEE 802.15.4 protocol.

Interface 418 can include one or more connectors, such as RF connectors, or Ethernet connectors, and/or wireless communication circuitry, such as 5G circuitry and one or more antennas.

GUI 419 may be any known device or system to display an interactive image to enable a user to interact with client device 102.

Client device 303, not shown in FIG. 4, is constructed and operates in a manner similar to that of client device 102. For purposes of discussion, client device 102 communicates with primary radio 424 of gateway device 301, which operates on the 2.4 GHz band. Client device 303 communicates with secondary radio 426 of gateway device 301, which operates on the 5 GHz band. However, client device 102 and client device 303 are configured to operate on either band.

Gateway device 301 includes a controller 420, which has stored therein a home network controller (HNC) 421; a memory 422, which has stored therein a hotspot program 423; and at least one radio, a sample of which is illustrated as a primary radio 424 and a secondary radio 426; and an interface 428. Primary radio 424, secondary radio 426, and interface 428 together makeup a primary communication system 430.

As will be described in greater detail below, primary communication system 430 is used during a primary mode of operation, wherein client device data is transponded between the respective client devices and the WAN by way of primary radio 424 in the 2.4 GHz band and secondary radio 426 in the 5 GHz band. In particular, secondary radio 424 will transpond data from devices in the 2.4 GHz band to the WAN, whereas radio 426 will transpond data from device in the 5 GHz band to the WAN.

Primary communication system 430 may operate in a hotspot mode of operation so as to transpond client device data between the respective client devices and the WAN via a hotspot wireless device and a wireless WAN. In particular, as will be described in greater detail below, primary communication system 433 is used during a hotspot mode of operation, when the primary WAN communication channel does down. In the hotspot mode of operation, client device data is transponded between the respective client devices and the WAN by way of primary radio 424 in the 2.4 GHz band and by secondary radio 426 in the 5 GHz band. In particular, secondary radio 424 will transpond data from devices in the 2.4 GHz band and the 5 GHz band to the WAN, by way of secondary radio 405 of hotspot client device 302.

In other words, in the primary mode of operation, primary radio 424 of gateway device 301 transponds 2.4 GHz client data to Internet 120 and secondary radio 426 of gateway device 301 transponds 5 GHz client data to Internet 120 via communication channel 114. However, if communication channel 114 goes down, gateway device 301 operates in a hotspot mode of operation wherein, primary radio 424 of gateway device 301 transponds 2.4 GHz client data to Internet 120 to Internet 120 via hotspot client device 302 and secondary radio 426 of gateway device 301 transponds 5 GHz client data to Internet 120 to Internet 120 via hotspot client device 302.

In this example, controller 420, memory 422, primary radio 424, secondary radio 426 and interface 428 are illustrated as individual devices. However, in some embodiments, at least two of controller 420, memory 422, primary radio 424, secondary radio 426, and interface 428 may be combined as a unitary device. Further, in some embodiments, at least one of controller 420 and memory 422 may be implemented as a computer having tangible computer-readable media for carrying or having computer-executable instructions or data structures stored thereon.

Controller 420 may be implemented as a hardware processor such as a microprocessor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software for controlling the operation and functions of gateway device 301 in accordance with the embodiments described in the present disclosure.

HNC 421 controls gateway device 301 within the wireless network. HNC 421 may perform tasks such as steering connected devices, a non-limiting example of which is a cell phone, from one access point to another.

Memory 422, as will be described in greater detail below, has instructions, including hotspot program 423, stored therein to be executed by controller 420 to allow gateway device 301 to: instruct primary communication system 430 to operate in a primary mode of operation so as to transpond client device data between client devices 102, 104, and 303 and Internet 120 and to transpond the wireless device data between hotspot client device 302 and Internet 120; detect a loss of connection with Internet 120; and instruct primary communication system 430 to operate in a hotspot mode of operation so as to transpond the client device data between client devices 102, 104, and 303 and Internet 120 via hotspot client device 302 and cellular network 310, wherein the primary communication system and the wireless communication system include secondary radio 426 configured to operate in the primary mode of operation in a band and to simultaneously operate in the hotspot mode of operation in the band.

In some embodiments, as will be described in greater detail below, primary communication system 430 includes an Ethernet communication system.

In some further embodiments, as will be described in greater detail below, primary communication system 430 additionally includes a wireless communication system.

In some of these embodiments, as will be described in greater detail below, primary communication system 430 is configured to transpond the client device data between client devices 102, 104, and 303 and Internet 120 via a data over a cable service interface specification (DOCSIS) communication channel.

In some of these embodiments, as will be described in greater detail below, primary communication system 430 is configured to transpond the client device data between client devices 102, 104, and 303 and Internet 120 via a passive optical network (PON) communication channel.

In some embodiments, as will be described in greater detail below, primary communication system 430 is configured to operate in the hotspot mode of operation as a client of hotspot client device 302 so as to transpond the client device data between client devices 102, 104, and 303 and Internet 120 via the hotspot client device 302 and cellular network 310 on the band, and wherein primary communication system 430 is configured to operate in the hotspot mode of operation by providing a fronthaul SSID to client devices 102, 104, and 303 on the band.

Primary radio 424 and secondary radio 426, may include a Wi-Fi WLAN interface radio transceiver that is operable to communicate with client device 301, extender 302 and external server 118. Primary radio 424 and secondary radio 426 includes one or more antennas and communicates wirelessly via one or more of the 2.4 GHz band, the 5 GHz band, the 6 GHz band, and the 6E GHz band, or at the appropriate band and bandwidth to implement any IEEE 802.11 Wi-Fi protocols, such as the Wi-Fi 4, 5, 6, or 6E protocols. Primary radio 424 and secondary radio 426 can also be equipped with a radio transceiver/wireless communication circuit to implement a wireless connection in accordance with any Bluetooth protocols, Bluetooth Low Energy (BLE), or other short range protocols that operate in accordance with a wireless technology standard for exchanging data over short distances using any licensed or unlicensed band such as the CBRS band, 2.4 GHz bands, 5 GHz bands, 6 GHz bands or 6E GHz bands, RF4CE protocol, ZigBee protocol, Z-Wave protocol, or IEEE 802.15.4 protocol.

Primary radio 424 operates on the 2.4 GHz band. Primary radio 424 is configured to communicate with client device 102 and hotspot client device 302. More specifically, primary radio 424 is configured to communicate with client device 102 and hotspot client device 302, while gateway device 301 remains connected to Internet 120. Further, primary radio 424 is configured to communicate with client device 102 in those instances when gateway device 301 is disconnected from Internet 120.

Secondary radio 426 operates on the 5 GHz band. Secondary radio 426 is configured to communicate with hotspot client device 302 and client device 303. When gateway device 301 is disconnected from Internet 120, secondary radio 426 simultaneously communicates with client device 303 as an access point, and with hotspot client device 301 as a client.

Interface 428 can include one or more connectors, such as RF connectors, or Ethernet connectors, and/or wireless communication circuitry, such as 5G circuitry and one or more antennas. Interface 428 receives data from external server 118 by known methods, non-limiting examples of which include terrestrial antenna, satellite dish, wired cable, DSL, optical fibers, or 5G as discussed above. Interface 428 is additionally configured to communicate with client device 104.

Primary communication system 430 is configured to enable gateway device 301 to operate in the primary mode of operation, wherein gateway device 301 is able to communicate with hotspot client device 302, client device 102, client device 104, and client device 303 in the primary mode of operation, wherein gateway device 301 is able to communicate with Internet 102 via communication channel 114 (and external server 118 and communication channel 116). In particular, in the primary mode of operation, primary radio 424 enables gateway device 301 to wirelessly communicate with client device 102, and hotspot client device 302, secondary radio 426 enables gateway device 301 to wirelessly communicate with client device 303, and interface 428 enables gateway device 301 to communicate with client device 104.

Primary communication system 430 is configured to enable gateway device 301 to operate in the hotspot mode of operation, wherein gateway device 301 is able to communicate with client device 102, client device 104, and client device 303 in the hotspot mode of operation, wherein gateway device 301 is able to communicate with Internet 102 via hotspot client device 302 (and cellular communication channel 306, cellular network 310, and wireless communication channel 312). In particular, in the hotspot mode of operation, primary radio 424 enables gateway device 301 to wirelessly communicate with client device 102 and interface 428 enables gateway device 301 to communicate with client device 104, and secondary radio 426 enables gateway device 301 to wirelessly communicate with client device 303. However, as opposed to the primary mode of operation, in the hotspot mode of operation, secondary radio 426 enables gateway device 301 to simultaneously wirelessly communicate with hotspot client device 302 over communication channel 312 so as to transpond data from client device 102, client device 104, and client device 303 to Internet 120 via cellular communication channel 306, cellular network 310 and wireless communication channel 312.

Secondary radio 426 is configured to act both as an access point for connected devices, and as a client device which connect to a hotspot device when gateway device 301 is disconnected from Internet 120. For purposes of the discussion, only client device 303 is connected to secondary radio 426, the 5 GHz band, during primary mode of operation. When gateway device 301 is disconnected from Internet 120, gateway device 301 will begin operating in hotspot mode. Gateway device 301 will receive and transmit data from client device 102 via primary radio 424, client device 104 via interface 428, and client device 303 via secondary radio 426. Gateway device 301 will then transmit and receive data from hotspot client device 302 via secondary radio 426.

For example, presume that primary radio 424 is operating on the 2.4 GHz band, composed of channels 1-12, and that secondary radio 426 is operating on the 5 GHz band, composed of channels 52-64. More specifically, primary radio 424 is operating on channel 8, and secondary radio 426 is operating on channel 63. During primary mode of operation, client device 102 and hotspot client device 302 will operate on channel 8, as they are both connected to primary radio 424. Client device 303 will operate on channel 63, as it is connected to secondary radio 426. When gateway device 301 disconnects from Internet 120, it will enter hotspot mode of operation, where client device 102 will continue to operate on channel 8, and client device 303 will continue to operate on channel 63. However, hotspot client device 302 will disconnect, and begin operating as a hotspot for gateway device 301 to connect to. Hotspot client device 302 will communicate with secondary radio 426 and connect to channel 63, where gateway device 301 will become a client device to hotspot client device 302. Gateway device 301 will simultaneously communicate with client devices 102 and 303 as an access point, on primary radio 424 and secondary radio 426 respectively.

In some embodiments, secondary radio 426 will not have connected devices during primary mode of operation, wherein secondary radio 426 will solely be used during hotspot mode of operation to transmit and receive data from hotspot client device 302.

In operation, for purposes of discussion, presume that client devices 102 and 104 and hotspot client device 302 are connected to LAN 308. Gateway device 301 is configured to monitor the connection status of gateway device 301 to Internet 120. Gateway device 301 may monitor the connection status of gateway device 301 to Internet 120 by any known method, a non-limiting example of which includes: controller 420, as shown in FIG. 4, executing instructions within memory 422 to instruct interface 428 to transmit an Internet Control Message Protocol (ICMP) echo request to external server 118; and controller 420 determining that an echo is not received by interface 428 in response to the ICMP echo request.

If is determined that the Internet has not disconnected (N at S208), the gateway device will continue to monitor the connection status of the Internet (Return to S208). For example, presume that gateway device 301 is operating in the primary mode of operation, and is providing Internet access to client devices 102 and 104 and hotspot client device 302. Gateway device 301 will continue to operate and monitor the connection status to Internet 120.

If is determined that the Internet has disconnected (Y at S208), the hotspot client device is instructed to operate as a hotspot (S210). For example, if wireless communication channel 114 is disconnected, gateway device 301 will contact hotspot client device 302 and instruct hotspot client device 302 to operate as a hotspot to allow client devices 102 and 104 to reconnect to LAN 308. This will be described in greater detail with reference to FIG. 3B.

FIG. 3B illustrates a communication system 300 at a time t₁ in accordance with aspects of the present disclosure.

As shown in FIG. 3B, wireless communication system 114 is crossed out, indicating that gateway device 301 no longer has access to Internet 120 through wireless communication channel 114.

Now consider the situation wherein gateway device 301 has been disconnected from Internet 120. Returning to FIG. 4, controller 420 of gateway device 301 is configured to execute instructions stored on memory 422, including hotspot program 423, to cause gateway device 301 to transmit instructions to hotspot client device 302 instructing hotspot client device 302 to operate in a hotspot mode of operation so as to begin operating as a hotspot. In the hotspot mode of operation, client device 302 will transpond client device data from client device 102, 103, and 303 to internet 120 via cellular network 310. Controller 400 of hotspot client device 302 is configured to execute instructions stored on memory 402, including hotspot program 403, causing primary radio 424 to instruct hotspot client device 302 to begin operating as a hotspot for LAN 308.

After the hotspot client device is instructed to operate as a hotspot (S210), the hotspot client device communicates with the Internet in place of the gateway device (S212). This will be described in greater detail with reference to FIG. 3C.

FIG. 3C illustrates a communication system 300 at a time t₂ in accordance with aspects of the present disclosure.

As shown in FIG. 3C, wireless communication channel 114 is disconnected from gateway device 301. Therefore, gateway device 301 still does not have access to Internet 120 through wireless communication channel 114. Further, as compared to FIG. 3B, wireless communication channel 304 has been replaced with wireless communication channel 312. Wireless communication channel 304 of FIG. 3B corresponds with a communication channel between primary radio 424 of gateway device 301 and hotspot client device 302 during the primary mode of operation. On the other hand, as shown in FIG. 3C, wireless communication channel 312 corresponds with a communication channel between gateway device 301 and hotspot client device 302 during the hotspot mode of operation, wherein secondary radio 426 of gateway device 301 communicates with secondary radio 405 of hotspot client device 302.

Now consider the situation wherein hotspot client device 302 has received instructions from gateway device 301 instructing hotspot client device 302 to begin operating as a hotspot for LAN 308, i.e., the hotspot mode of operation. Hotspot client device 302 will ultimately provide access to Internet 120 for all other client devices. In particular, cellular radio 406 of hotspot client device 302 will communicate with Internet 120 through cellular communication channel 306, cellular network 310, and wireless communication channel 312.

Gateway device 302 will instruct hotspot client device 302 to provide internet accesses to the remaining client devices by way of cellular communication channel 306. In particular, controller 420 of gateway device 302 is configured to execute instructions stored on memory 422, including hotspot program 423, to instruct secondary radio 426 to communicate with secondary radio 405 of hotspot client device 302. Gateway device 302 will instruct hotspot client device 302 to provide transpond data from client device 102, client device 104 and client device 303 with Internet 120.

More particularly, gateway device 302 will instruct hotspot client device 302 to transpond data from client device 102, client device 104 and client device 303 to Internet 120 by way of cellular network 310.

As shown in FIG. 3C, client device 102, client device 104, and client device 303 are therefore able to continue to maintain access to Internet 120 by being connected to gateway device 301. Secondary radio 426 of gateway device 301 will provide access to Internet 120 to client device 303, while simultaneously providing client device data of all connected devices to hotspot client device 302.

Returning to FIG. 2, after the hotspot client device communicates with the Internet in place of the gateway device (S212), it is determined whether the WAN reconnection is detected (S214). For example, as shown in FIG. 4, controller 420 of gateway device 302 is configured to execute instructions stored on memory 422, including hotspot program 423, to cause gateway device 301 to attempt to reconnect to Internet 120 through communication channel 114. Hotspot client device 302 providing internet access to LAN 308 is a temporary solution. As soon as gateway device 301 is able to reconnect to Internet 120 via communication channel 114, gateway device 301 will instruct hotspot client device 302 to stop operating as a hotspot and reconnect to primary radio 424 via primary radio 404.

If it is determined that the Internet has not reconnected (N at S214), the hotspot client device continues to maintain communication with the Internet (Return to S212). For example, if gateway device 301 monitors communication channel 114 and finds that it is still inactive, hotspot client device 302 will continue to act as a hotspot for LAN 308. This process will continue until gateway device 301 is able to connect to Internet 120 via communication channel 114.

If it is determined that the Internet has reconnected (Y at S214), the hotspot client device is instructed to stop operating as a hotspot (S216). For example, presume that while hotspot client device 302 is operating as a hotspot for LAN 308, gateway device 301 determines that communication channel 114 is active again. Controller 420 of gateway device 302 is configured to execute instructions stored on memory 422, including hotspot program 423, to cause secondary radio 426 to instruct hotspot client device 302 to stop operating as a hotspot for LAN 308.

After the hotspot client device is instructed to stop operating as a hotspot (S216), the gateway device once again checks if the Internet has been disconnected (Return to S208). For example, gateway device 301 will operate normally until there is another disconnection from Internet 120 via communication channel 114.

Internet disconnections can occur for a multitude of reasons, all of which are inconvenient to users operating network devices. Further, network disconnections can last for an extended period of time. When the users have urgent business to take care of, this can be a serious problem.

In accordance with the present disclosure, a gateway device is used with a hotspot client device. The hotspot client device will connect to the network through its primary radio. If the gateway device is disconnected from the Internet, the gateway device will instruct the hotspot client device to activate its secondary radio and operate as a hotspot for the Internet. The hotspot client device will operate as a hotspot and connect to the Internet through the use of a third cellular radio. The gateway device will connect to the hotspot device. The gateway device will provide Internet access to all connected devices through the use of its primary radio and secondary radio. However, the secondary radio will also be connected to the secondary radio of the hotspot client device, where it acts as both an access point and a client device simultaneously. Once the gateway device is able to reconnect to the Internet via its primary channel communication, the hotspot client device will be instructed to stop operating as a hotspot.

Thus, the present disclosure as disclosed allows a hotspot client device to temporarily provide Internet access to a gateway device until the gateway device is able to reconnect to the network.

The operations disclosed herein may constitute algorithms that can be effected by software, applications (apps, or mobile apps), or computer programs. The software, applications, computer programs can be stored on a non-transitory computer-readable medium for causing a computer, such as the one or more processors, to execute the operations described herein and shown in the drawing figures.

The foregoing description of various preferred embodiments have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A gateway device for use with a wide area network, wireless wide area network, a local area network, a client device and a wireless device, the client device being configured to transmit client device data to the wide area network via the local area network and said gateway device, the wireless device being configured to operate in a first mode so as to wirelessly transmit wireless device data to the wide area network via the local area network and said gateway device and being configured to operate in a hotspot mode so as to wirelessly transmit the wireless device data and the client device data to the wide area network via the wireless wide area network, said gateway device comprising:
a memory;
a primary communication system configured to transpond the client device data between the client device and the wide area network and to transpond the wireless device data between the wireless device and the wide area network;
a wireless communication system configured to transpond the client device data between the client device and the wide area network via the wireless device and the wireless wide area network; and
a processor configured to execute instructions stored on said memory to cause said gateway device to:
instruct said primary communication system to operate in a primary mode of operation so as to transpond the client device data between the client device and the wide area network and to transpond the wireless device data between the wireless device and the wide area network;
detect a loss of connection with the wide area network; and
instruct said primary communication system and said wireless communication system to operate in a hotspot mode of operation so as to transpond the client device data between the client device and the wide area network via the wireless device and the wireless wide area network,
wherein said primary communication system and said wireless communication system comprise a radio configured to operate in the primary mode of operation in a band and to simultaneously operate in the hotspot mode of operation in the band.

2. The gateway device of claim 1, wherein said primary communication system comprises an Ethernet communication system.

3. The gateway device of claim 2, wherein said primary communication system additionally comprises a wireless communication system.

4. The gateway device of claim 3, wherein said primary communication system is configured to transpond the client device data between the client device and the wide area network via a data over a cable service interface specification communication channel.

5. The gateway device of claim 3, wherein said primary communication system is configured to transpond the client device data between the client device and the wide area network via a data over a passive optical network communication channel.

6. The gateway device of claim 1,
wherein said wireless communication system is configured to operate in the hotspot mode of operation as a client of the wireless device so as to transpond the client device data between the client device and the wide area network via the wireless device and the wireless wide area network on the band, and
wherein said wireless communication system is configured to operate in the hotspot mode of operation by providing a fronthaul SSID to the client device on the band.

7. A method of using a gateway device with a wide area network, wireless wide area network, a local area network, a client device and a wireless device, the client device being configured to transmit client device data to the wide area network via the local area network and the gateway device, the wireless device being configured to operate in a first mode so as to wirelessly transmit wireless device data to the wide area network via the local area network and the gateway device and being configured to operate in a hotspot mode so as to wirelessly transmit the wireless device data and the client device data to the wide area network via the wireless wide area network, said method comprising:
instructing, via a processor configured to execute instructions stored on a memory, a primary communication system to operate in a primary mode of operation so as to transpond the client device data between the client device and the wide area network and to transpond the wireless device data between the wireless device and the wide area network;
detecting, via the processor, a loss of connection with the wide area network; and
instructing, via the processor, the primary communication system and a wireless communication system to operate in a hotspot mode of operation so as to transpond the client device data between the client device and the wide area network via the wireless device and the wireless wide area network,
wherein the primary communication system and the wireless communication system comprise a radio configured to operate in the primary mode of operation in a band and to simultaneously operate in the hotspot mode of operation in the band.

8. The method of claim 7, wherein said instructing, via the processor configured to execute instructions stored on a memory, the primary communication system to transpond the client device data between the client device and the wide area network and to transpond the wireless device data between the wireless device and the wide area network comprises instructing an Ethernet communication system to transpond the client device data between the client device and the wide area network and to transpond the wireless device data between the wireless device and the wide area network.

9. The method of claim 8, wherein said instructing, via the processor configured to execute instructions stored on a memory, the primary communication system to transpond the client device data between the client device and the wide area network and to transpond the wireless device data between the wireless device and the wide area network additionally comprises instructing a wireless communication system to transpond a portion of the client device data between the client device and the wide area network and to transpond a portion of the wireless device data between the wireless device and the wide area network.

10. The method of claim 9, wherein said instructing, via the processor configured to execute instructions stored on a memory, the primary communication system to transpond the client device data between the client device and the wide area network and to transpond the wireless device data between the wireless device and the wide area network comprises instructing the primary communication system to transpond the client device data between the client device and the wide area network and to transpond the wireless device data between the wireless device and the wide area network via a data over a cable service interface specification communication channel.

11. The method of claim 9, wherein said instructing, via the processor configured to execute instructions stored on a memory, the primary communication system to transpond the client device data between the client device and the wide area network and to transpond the wireless device data between the wireless device and the wide area network comprises instructing the primary communication system to transpond the client device data between the client device and the wide area network and to transpond the wireless device data between the wireless device and the wide area network via a passive optical network communication channel.

12. The method of claim 7,
wherein said instructing the primary communication system and a wireless communication system to operate in a hotspot mode of operation comprises instructing the wireless communication system to operate in the hotspot mode of operation as a client of the wireless device so as to transpond the client device data between the client device and the wide area network via the wireless device and the wireless wide area network on the band, and
wherein said instructing the primary communication system and a wireless communication system to operate in a hotspot mode of operation additionally comprises instructing the wireless communication system to operate in the hotspot mode of operation by additionally providing a fronthaul SSID to the client device on the band.

13. A non-transitory, computer-readable media having computer-readable instructions stored thereon, the computer-readable instructions being capable of being read by a gateway device for use with a wide area network, wireless wide area network, a local area network, a client device and a wireless device, the client device being configured to transmit client device data to the wide area network via the local area network and the gateway device, the wireless device being configured to operate in a first mode so as to wirelessly transmit wireless device data to the wide area network via the local area network and the gateway device and being configured to operate in a hotspot mode so as to wirelessly transmit the wireless device data and the client device data to the wide area network via the wireless wide area network, wherein the computer-readable instructions are capable of instructing the client device to perform the method comprising:
instructing, via a processor configured to execute instructions stored on a memory, a primary communication system to operate in a primary mode of operation so as to transpond the client device data between the client device and the wide area network and to transpond the wireless device data between the wireless device and the wide area network;
detecting, via the processor, a loss of connection with the wide area network; and
instructing, via the processor, the primary communication system and a wireless communication system to operate in a hotspot mode of operation so as to transpond the client device data between the client device and the wide area network via the wireless device and the wireless wide area network,
wherein the primary communication system and the wireless communication system comprise a radio configured to operate in the primary mode of operation in a band and to simultaneously operate in the hotspot mode of operation in the band.

14. The non-transitory, computer-readable media of claim 13, wherein the computer-readable instructions are capable of instructing the client device to perform the method wherein said instructing, via the processor configured to execute instructions stored on a memory, the primary communication system to transpond the client device data between the client device and the wide area network and to transpond the wireless device data between the wireless device and the wide area network comprises instructing an Ethernet communication system to transpond the client device data between the client device and the wide area network and to transpond the wireless device data between the wireless device and the wide area network.

15. The non-transitory, computer-readable media of claim 14, wherein the computer-readable instructions are capable of instructing the client device to perform the method wherein said instructing, via the processor configured to execute instructions stored on a memory, the primary communication system to transpond the client device data between the client device and the wide area network and to transpond the wireless device data between the wireless device and the wide area network additionally comprises instructing a wireless communication system to transpond a portion of the client device data between the client device and the wide area network and to transpond a portion of the wireless device data between the wireless device and the wide area network.

16. The non-transitory, computer-readable media of claim 15, wherein the computer-readable instructions are capable of instructing the client device to perform the method wherein said instructing, via the processor configured to execute instructions stored on a memory, the primary communication system to transpond the client device data between the client device and the wide area network and to transpond the wireless device data between the wireless device and the wide area network comprises instructing the primary communication system to transpond the client device data between the client device and the wide area network and to transpond the wireless device data between the wireless device and the wide area network via a data over a cable service interface specification communication channel.

17. The non-transitory, computer-readable media of claim 15, wherein the computer-readable instructions are capable of instructing the client device to perform the method wherein said instructing, via the processor configured to execute instructions stored on a memory, the primary communication system to transpond the client device data between the client device and the wide area network and to transpond the wireless device data between the wireless device and the wide area network comprises instructing the primary communication system to transpond the client device data between the client device and the wide area network and to transpond the wireless device data between the wireless device and the wide area network via a passive optical network communication channel.

18. The non-transitory, computer-readable media of claim 13, wherein the computer-readable instructions are capable of instructing the client device to perform the method
wherein said instructing the primary communication system and a wireless communication system to operate in a hotspot mode of operation comprises instructing the wireless communication system to operate in the hotspot mode of operation as a client of the wireless device so as to transpond the client device data between the client device and the wide area network via the wireless device and the wireless wide area network on the band, and
wherein said instructing the primary communication system and a wireless communication system to operate in a hotspot mode of operation additionally comprises instructing the wireless communication system to operate in the hotspot mode of operation by additionally providing a fronthaul SSID to the client device on the band.
